(19) United States
(12) Patent Application Publication
(10) Pub. No.: US 2010/0095343 A1
(43) Pub. Date: Apr. 15, 2010

(54) Audiovisual Apparatus, Method of Controlling an Audiovisual Apparatus, and Method of Distributing Data

(75) Inventor: Takahisa Kaihotsu, Musashino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/536,055

(22) Filed: Aug. 5, 2009

(30) Foreign Application Priority Data
Oct. 10, 2008 (JP) 2008-264378

(51) Int. Cl. H04N 7/173

(52) U.S. Cl. 725/118

(57) ABSTRACT

According to one embodiment, an embodiment of this invention provides an audiovisual apparatus that enables a plurality of users to appreciate one program as if they were got together, and a method controlling the apparatus. In the audiovisual apparatus, the broadcast-program signal processing module processes the broadcast program signal received at the first reception module and outputs the broadcast program signal to the first display area. The grouped-video signal processing module processes the grouped video signal received at the second reception module and outputs the same, in the form of a multi-image, to the second display area. Meanwhile, the transmission module processes a pickup image signal and outputs the same to an external apparatus.

### CROSS-REFERENCE TO RELATED APPLICATIONS

This application is based upon and claims the benefit of priority from Japanese Patent Application No. 2008-264378, filed Oct. 10, 2008, the entire contents of which are incorporated herein by reference.

### BACKGROUND

1. Field

One embodiment of the invention relates to an audiovisual apparatus, a method of controlling an audiovisual apparatus, and a method of distributing data. More particularly, the invention relates to a technique that expands the Social Graph, and can therefore stimulate the communication system for many viewers.

2. Description of the Related Art

Methods of controlling image-playback have been proposed, which help users geographically remote from one another to feel as if they had got together and were viewing the same image at the same place. (See, for example, Jpn. Pat. Appln. No. 2003-163893.)

In this technique, a plurality of users transmit information items of interest to them, to a server. In the server, the users are classified into groups, each consisting of those who have similar tastes. Any user can apply for admission to a community to belong to a user group, or can apply for withdrawal from the community to leave the user group. Once a user has joined the user group, the server transmits an image-playback command to the user, enabling the user to view the same image as the other users of the group view.

The technique described above enables the users to view the same image, helping them to communicate with one another. TV conference systems are available as systems that contribute to communication. With the TV conference technique, however, the participants need to register themselves beforehand at the provider, and then can, but only exchange images with one another. Inevitably, the human relation possible with the technique is exclusive, not enabling the registered participants to enjoy images together with new participants (e.g., friends' friends). Further, with the conventional technique, much labor is required to register all participants at a particular provider, and each participant cannot easily switch the provider to any other.

It is therefore increasingly demanded that a more realistic environment be provided, in which “a plurality of users view the same image” and the users can easily switch from one to another.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram showing the basic configuration of an embodiment of the present invention;

FIG. 2 is a diagram showing a client TV and a server according to the embodiment, in more detail than in FIG. 1;

FIG. 3 is a diagram showing the graphic user interface and the remote controller, both used in the apparatus according to this invention;

FIG. 4 is a diagram showing an exemplary user data table used in the embodiment of this invention;

FIG. 5 is a diagram showing an exemplary multi-image displayed on the sub-display of the client TV;

FIG. 6 is a diagram showing a social graph for explaining the embodiment;

FIG. 7 is a diagram showing how a scope and a channel are set to a node in the social graph;

FIG. 8 is a diagram showing an exemplary selector table used in the embodiment of this invention;

FIG. 9 is a flowchart showing an exemplary sequence of setting user data in the embodiment of this invention;

FIG. 10 is a diagram showing an exemplary user data table processed in the sequence shown in the flowchart of FIG. 9;

FIG. 11 is a diagram showing channel data described in the user data table of FIG. 10;

FIG. 12 is a diagram showing an exemplary sequence of connecting the client TV to the server;

FIG. 13 is a diagram showing the state in which channel=9 and scope=2 that are set to the node of “ID=0” in the social graph, in the embodiment of the invention;

FIG. 14 is a diagram explaining an exemplary sequence of transmitting a stream from the client to the server;

FIG. 15 is a flowchart explaining how a distance list is generated for each node of the social graph);

FIG. 16 is a part of the flowchart of FIG. 15, explaining the function of setting the distance list;

FIG. 17 is a diagram showing an exemplary social graph;

FIG. 18 is a diagram showing a state in which specific distances are set between the nodes of the social graph;

FIG. 19 is a diagram showing another state in which specific distances are set between the nodes of the social graph;

FIG. 20 is a diagram showing a further state in which specific distances are set between the nodes of the social graph;

FIG. 21 is a diagram showing a different state in which specific distances are set between the nodes of the social graph;

FIG. 22 is a diagram showing another state in which specific distances are set between the nodes of the social graph;

FIG. 23 is a diagram showing a different state in which specific distances are set between the nodes of the social graph;

FIG. 24 is a diagram showing another state in which specific distances are set between the nodes of the social graph;

FIG. 25 is a diagram showing another state in which specific distances are set between the nodes of the social graph;

FIG. 26 is a diagram showing a further state in which specific distances are set between the nodes of the social graph;

FIG. 27 is a diagram showing a different state in which specific distances are set between the nodes of the social graph;

FIG. 28 is a diagram explaining the sequence of generating a selector table for one client TV (destination);

FIG. 29 is a diagram showing an exemplary selector table generated in the sequence of FIG. 28;

FIG. 30 is a diagram showing the sequence of distributing a stream from the server to a client TV (destination);

FIG. 31 a diagram explaining how friends enjoy viewing the same program, on the sub-displays of different client TVs; and

FIG. 32 is a diagram explaining how the sub-displays of two client TVs display are displayed in another embodiment of the present invention.

### DETAILED DESCRIPTION

Various embodiments according to the invention will be described hereinafter with reference to the accompanying drawings.

According to the present invention an audiovisual apparatus and a control method for the apparatus are provided. The apparatus and the method make remote plural users able to see or appreciate a program as if all seeing the program together based on a human relation of the social graph (hereinafter referred to as SG).

One embodiment of the present invention has, as basic components, a broadcast-program signal processing module, a grouped-video signal processing module, and a transmission module. The broadcast-program signal processing module processes a broadcast program signal received by a first reception module and outputs the broadcast program signal to a first display area. The grouped-video signal processing module processes a grouped video signal received by a second reception module and outputs the grouped video signal, in the form of a multi-image, to a second display area. The transmission module processes a pickup image signal and transmits the pickup image signal to an external apparatus.

The embodiment enables a plurality of users to appreciate the same program as if they got together in the same place, owing to the human relation achieved by the social graph (hereinafter referred to as SG), merely by performing an operation to join in the community of the SG.

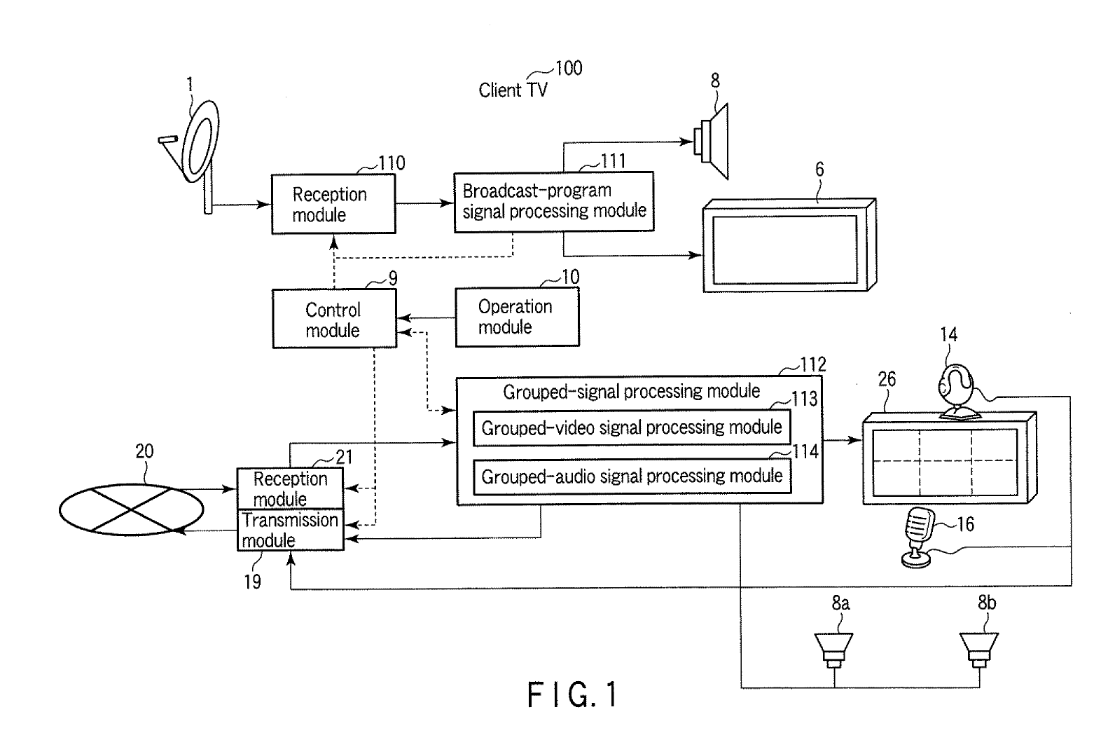

The embodiment of the invention will be described in more detail. FIG. 1 shows the basic configuration of the embodiment.

This apparatus is constituted as, for example, a client television receiver (hereinafter referred to as “client TV”) 100. The broadcast program signal caught by an antenna 1 is supplied to a reception module 110. The broadcast program signal received by the reception module 110 is decoded by a broadcast-program signal processing module 111. The broadcast-program signal processing module 111 decodes the program signal, generating an audio signal and a video signal. The audio signal is supplied to a speaker 8. The video signal is supplied to a main display 6.

The signal on the Internet is received by a reception module 21. The grouped signals (described later) included in the signal received are input to a grouped-signal processing module 112. One grouped signal is a grouped video signal, and the other grouped signal is a grouped audio signal. These signals are processed in a grouped-video signal processing module 113 and a grouped-audio signal processing module 114, respectively. The video signal processed is displayed by a sub-display 26 as a multi-image. The audio signal processed is supplied to speakers 8a and 8b.

A camera (a video camera) 14 and a microphone 16 are installed near, for example, the sub-display 26 or the seat on which the viewer is sitting. Thus, the camera 14 can pickup a movie video of the viewer and the microphone 16 can pick up any speech the viewer makes. A pickup-image signal generated by the camera 14 and an audio signal generated by the microphone 16 are transmitted to a prescribed server via a transmission module 19 and the Internet 20.

A control module 9 controls the other blocks shown in FIG. 1. The control module 9 receives an operation signal from an operation module 10 and controls the operating mode of the client TV 100.

The display 26 may be a display designed for use by a combination of personal computers. Further, the display 26 may be replaced by several displays, which display a multi-image. The displays 6 and 26 are components independent of each other. They may be replaced by a single display, the screen of which is divided into two.

In the apparatus described above, the broadcast-program signal processing module 111 processes the broadcast program signal received by the reception module 110, and the signal processed is output to the display 6. The grouped video signal the reception module 21 has received is processed in the grouped-video signal processing module 113 and output to the display 26, which displays a multi-image. Moreover, the transmission module 19 transmits an image signal to an external apparatus. Further, the transmission module 19 acquires control data from the control module 9 and transmits, to the external apparatus, the user data used as reference data to generate channel data about the channel now being viewed and the grouped video signal.

With the basic configuration described above, the users can appreciate the same program, as if they had got together in the same place, owing to the human relation achieved by the social graph (SG). That is, if any user inputs a scope (search region in the SG), the nodes (hereinafter called “friend nodes” connected in the search region are extracted from the social graph (SG), and the images and speeches of the friends associated with friend nodes (hereinafter referred to as “stream”) are displayed on the audiovisual apparatus of the user. Further, the user's own stream can be distributed to the friends' audiovisual apparatuses.

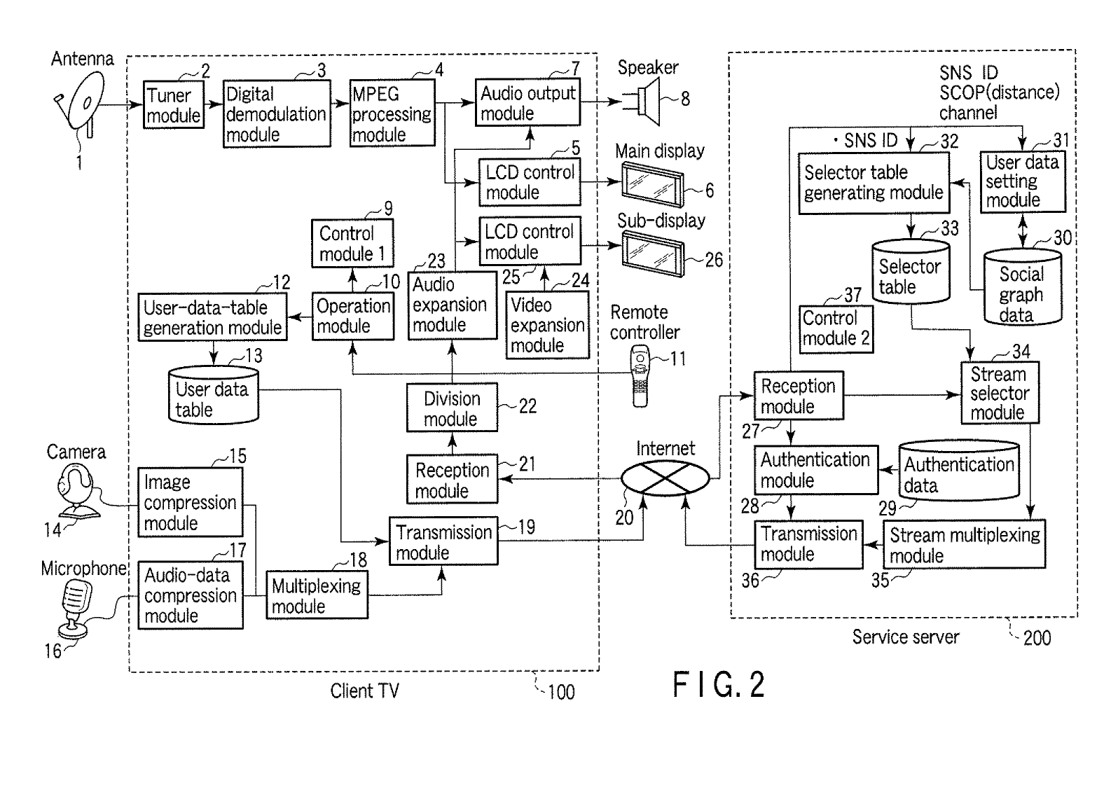

A combination of a client television receiver (hereinafter called “client TV”) and a service server (hereinafter called “server”) will be described as a specific embodiment of the invention, with reference to FIG. 2.

An exemplary configuration of the client TV will be described first. An antenna 1 is connected to a tuner module 2 and receives a terrestrial digital broadcast program. The tuner module 2 is the component that selects and receives a TV-broadcast signal. In this embodiment, the tuner module 2 is designed to receive a digital broadcast signal an the selected channel and to convert the signal to an intermediate-frequency (IF) signal. A digital modulation module 3 extracts a digital signal (i.e., transport stream (TS)) from the IF signal. The transport stream extracted is supplied to an MPEG processing module 4. The MPEG processing module 4 processes the transport stream supplied from the MPEG processing module 4, decoding the video/audio data contained in the transport stream. The video data decoded is transferred to a liquid-crystal-device control module (hereinafter called LCD control module) 5. The audio data decoded is supplied to an audio output module 7, which generates the sound represented by the audio data.

The LCD control module 5 supplies the video data to a main display 6, which displays the image the video data represents. The main display 6 is connected to the LCD control module 5 and displays the video data the MPEG processing module 4 has decoded. That is, the main display 6 is a display that displays the terrestrial digital broadcast program.

The audio output module 7 is connected to a speaker 8 and outputs the audio data received from the audio output module 7, to the speaker 8. At the same time, the audio output module 7 outputs the audio data an audio expansion module 23 has output. The speaker 8 is connected to the audio output module 7 and generates sound.

A control module 9 that controls some of the other components of the client TV. The control module 9 comprises a ROM (not shown) and a RAM (also not shown). The ROM stores control programs. The RAM is provided to store work data, for example, current user number that is necessary in the process that will be described later.

An operation module 10 receives a control command and transfers the command to the control module 9. A remote controller 11 is a device the user may operate to perform operations pertaining to the present invention. The remote controller 11 gives control commands to the operation module 10 by wireless communication using infrared rays. The remote controller 11 has a ten-key keypad the user may operate to input numerical data. When operated, the remote controller 11 can input channel numbers. The remote controller 11 has a cross key, too. Hence, the remote controller 11 can function as a graphical user interface (GUI) that includes a software keyboard the user may operate to input character data such as a password.

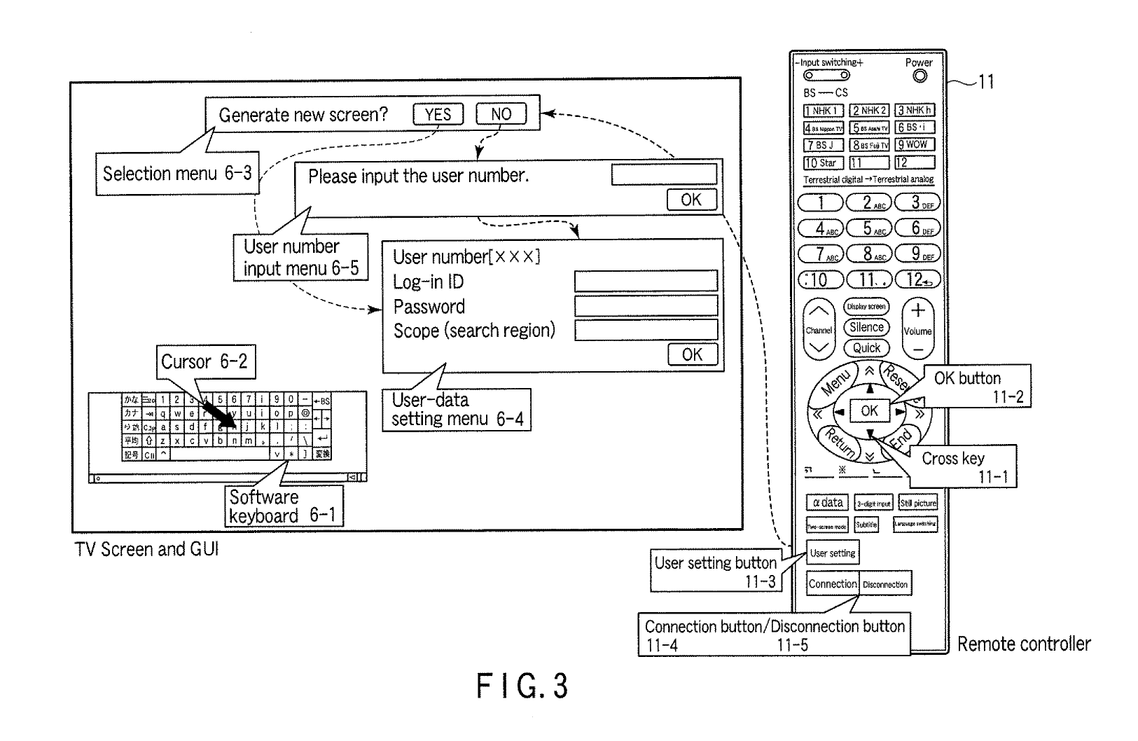

FIG. 3 shows an exemplary GUI that may be controlled as the user operates the remote controller 11. When the GUI is so controlled, the main display 6 displays a software keyboard 6-1 and a cursor 6-2. Then, the user operates the cross key on the remote controller 11, moving the cursor 6-2 to the keyboard 6-1. While the cursor 6-2 remains at the keyboard 6-1, the user pushes the OK button 11-2, selecting a character. Note that the remote controller 11 has a user-setting button 11-3 for activating the GUI the user has set, a connection button 11-4 for connecting the client TV to a service server, and a disconnection button 11-5 for disconnecting the client TV from the service server.

With reference to FIG. 2 again, the embodiment will be described further. A user-data-table generation module 12 generates a user data table 13 that stores an ID, a password, and a scope. The ID and the password are used to enable the user viewing the TV to log-in to the service server. The scope (i.e., distance at which the client TV is located from the service server) designates a region of the social graph (SG) which should be searched.

The user data table 13, which is set in a memory, stores the personal data generated by the user-data-table generation module 12, such as the log-in ID of the server, and also the channel data about the channel the user is now viewing, which the control module 9 has written.

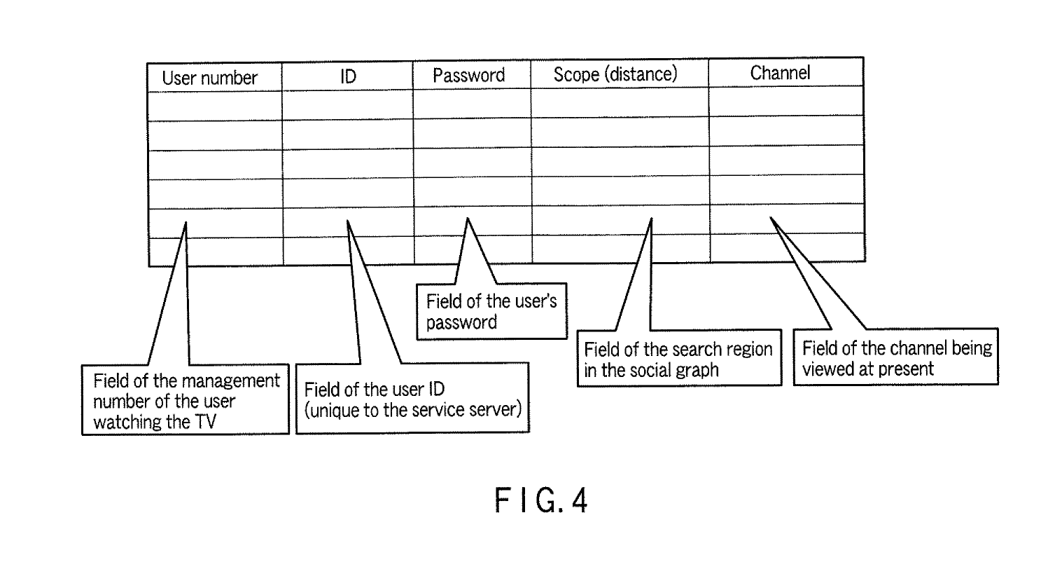

In FIG. 4, an example of a user data table 13 is illustrated. The user data table 13 shows a user number, ID, password, scope (distance) and channel, all pertaining to a user. The user number is a user management number the control module 9 has issued. Only one number, “0,” is allocated because only one user watches the client TV. The ID is one for achieving a log-in and is “0” in this embodiment, for the sake of simplicity. The password is used to identify the user to authenticate him or her in accordance with the ID. The password is “soccer” in the present embodiment. The scope indicates the region in the social graph, in which to search for friends, and is, for example “2,” in the present embodiment. The channel is a field in which the control module 9 sets the number of the channel the user is now viewing. The data set of each row (i.e., ID, password, scope and channel) in the user data table is called “user data” in this embodiment.

With reference to FIG. 2 once again, a camera 14 photographs the user who sits in front of the client TV. An image compression module 15 encodes the image the camera 14 has photographed. A microphone 16 is the means for input the speech the user sitting before the client TV has made. An audio-data compression module 17 encodes the speech input by the microphone 16. A multiplexing module 18 performs the process of arranging, on a time axis, two outputs from the image compression module 15 and the audio-data compression module 17, respectively, thereby to transmit the two outputs through one transmission path.

A transmission module 19 transmits the above-mentioned user data and audiovisual data (called “stream” hereinafter), i.e., output of the multiplexing module 18, to the server according to this embodiment via the Internet 20. The transmission module 19 uses the H323 protocol, which is widely known as the standard for multimedia real time communication.

The Internet 20 is a computer network that connects the networks over the world, using the communications protocol TCP/IP. A reception module 21 receives the stream transmitted from the server.

A division module 22 first divides a multiplexed stream into streams and then divides each stream into audio data and video data. The audio data and the video data are supplied to an audio expansion module 23 and a video expansion module 24, respectively.

The audio expansion module 23 receives the audio data from the division module 22, expends the audio data, and supplies the audio data to the audio output module 7. Nonetheless, the audio data need not always be sent to the audio output module 7. Instead, the audio data may be supplied to another audio output module.

The video expansion module 24 receives the video data from the division module 22 and expands the same. The video data expended is supplied to a LCD control module 25. The LCD control module 25 receives video data items sent from the video expansion module 24 and supplies them to sub-display 26. The sub-display 26 displays the images represented by the respective streams in a multi window. The sub-display 26 is connected to the LCD control module 25 and displays the images represented by the video data items the video expansion module 24 has decoded.

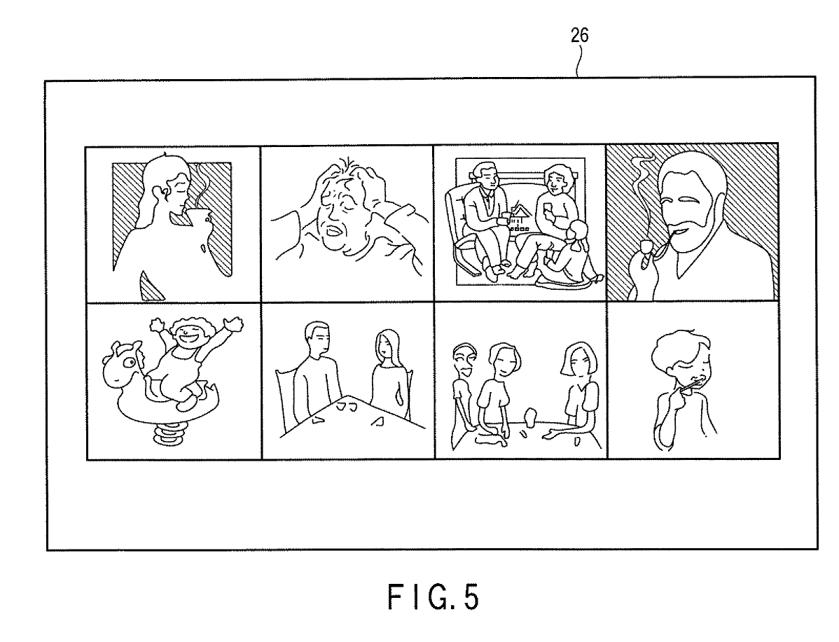

FIG. 5 shows eight exemplary video data items (representing the images photographed by eight cameras). If the video data items coming from other client TVs further increase in number, more images may be displayed in the multi-window. Alternatively, the eight images as shown in FIG. 5 may be scrolled at a prescribed speed so that the user may view other images.

With reference to FIG. 2 again, an exemplary configuration of the service server will be described. A reception module 27 is connected to the client TV via the Internet 20 and receives user data and streams from the client TV. The reception module 27 is connected to a plurality of client TVs via the Internet 20 as in most cases.

An authentication module 28 uses the ID and password, which are contained in the user data the reception module 27 has received, and also authentication data 29, to determine whether the client TV can be connected to the service server.

The authentication data 29, which is stored in a memory, holds the ID and password that the authentication module 28 refers to. In this embodiment, the server has the authentication module 28 and holds the authentication data 29, for the sake of simplicity. Nonetheless, an “authentication system” that can be used beyond the site and an authentication protocol “OpenID” that provides “ID for use in the system” may be utilized instead.

The memory stores social graph data 30, which represents a graph showing the relation between a certain user and his or her friends. The social graph data 30 has an attribute that defines the relation between the user and the friends. That is, the graph uses nodes and edges to represent the human relation. In the present embodiment, the nodes indicate the persons (or client TVs) and each edge indicates the relation between two nodes. The social graph data is the basic data utilized in social network services (SNSs) broadly known in the art, such as “mixi” (registered trademark), “Facebook” (registered trademark), and “MySpace” (registered trademark).

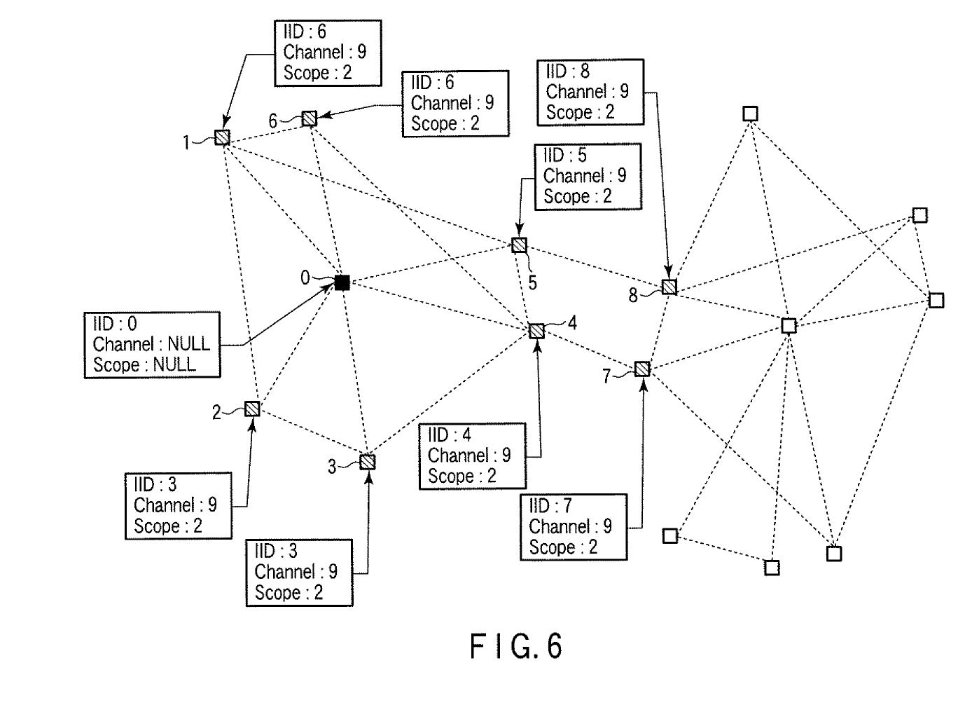

FIG. 6 shows an exemplary social graph for explaining this embodiment. As shown in FIG. 6, unique IDs are allocated to the nodes (indicated by squares), respectively. The IDs are identical to the numbers assigned to the nodes, for the sake of simplicity. Of the nodes connected to the node having an ID of 0 (ID=0), the nodes having IDs of 1 to 6 are direct friends of the node that has an ID of 0, whereas the nodes having IDs of 7 and 8 are the friends' friends, as is seen from FIG. 6. Each node has a storage area for storing a channel and a scope (later described), both utilized in the present embodiment. Assume that the nodes having IDs of 1 to 8 hold a channel value and a scope value each, which are shown in FIG. 6.

In this embodiment, the server holds social graph data, for the sake of simplicity. Nonetheless, the server may use “DataPortability” (registered trademark) that is a technique of achieving common use data in the SNS.

With reference to FIG. 2 again, the embodiment will be further described. A user data setting module 31 uses the ID and scope, both contained in the user data the reception module 27 has received, and also the channel data contained in the user data and presenting the channel now selected at the client TV. The user data setting module 31 thus sets the scope and the channel at the node that is associated with the ID contained in the social graph data 30.

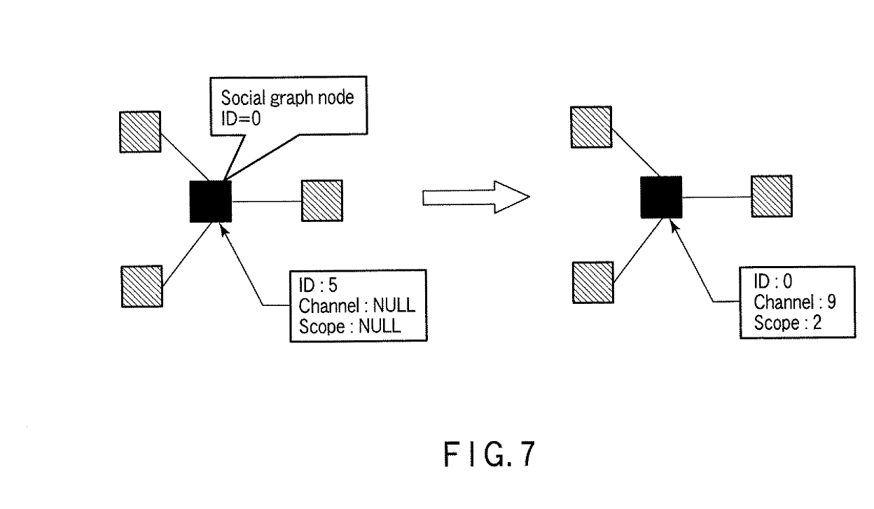

FIG. 7 shows the case where the scope and the channel are set at a node of the social graph. In this social graph, the shorter the distance between any two nodes for two users, the higher the intimacy it indicates about the users. This distance is called “scope” in the present embodiment. If any node has a scope of 1, it is connected to the user, indicating a direct friend of the user. If the node has a scope of 2, it indicates a friend of the user's friend.

With reference to FIG. 2 again, a selector table generating module 32 uses the user's ID received by the reception module 27 and the social graph data set by the user data setting module 31. Thus, the selector table generating module 32 generates a selector table 33 that defines to which client TV the stream of a specific client TV should be distributed.

The selector table 33, which is stored in a memory, is a table that describes the user ID of the client TV (called “destination”) and the ID list (called “source”) of the user who distributes a stream to the client TV. This table is generated by the selector table generating module 32.

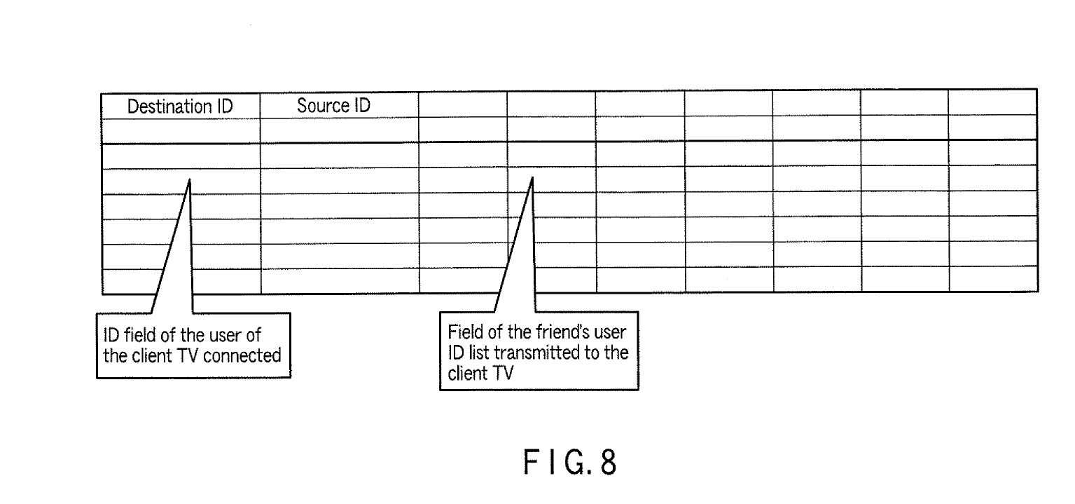

FIG. 8 shows an exemplary selector table 33. With reference to FIG. 8 and FIG. 2, the embodiment will be further described. A stream selector module 34 has the function of recognizing any client TV to which to transmit the stream and selecting the stream the reception module 27 has acquired from any other client TV, on the basis of the selector table 33.

A stream multiplexing module 35 has the function of multiplexing the stream the stream selector module 34 has selected and supplying the stream to a transmission module 36.

The transmission module 36 transmits the audiovisual data (hereinafter called “multiplexed stream”) received from the other client TV and multiplexed by the stream multiplexing module 35, to the client TV via the Internet 20. In the client TV, the reception module 21 receives the stream. The sub-display 26 displays the stream.

The service server has a control module 37, which is a processing module that controls the other processing modules of the service server. The server needs to authenticate the client TV, generate a selector table and distribute a multiplexed stream, in an appropriate order. The control module 37 performs other operations such as a sequence control.

The control module 37 comprises a ROM and a RAM (neither are shown). The ROM stores control programs. The RAM stores the IP addresses of the client TVs connected to the server to receive multiplexed streams, and other data items.

The present embodiment will be further described on the assumption that the user is viewing the “ninth channel.” First, (1) how the user data is set will be explained. Then, (2) how the client TV is connected to the server will be explained. Finally, (3) how friends (ID=1 to 8) watch a stream on the sub-display of the client TV (ID=0) will be explained.

Setting of the User Data

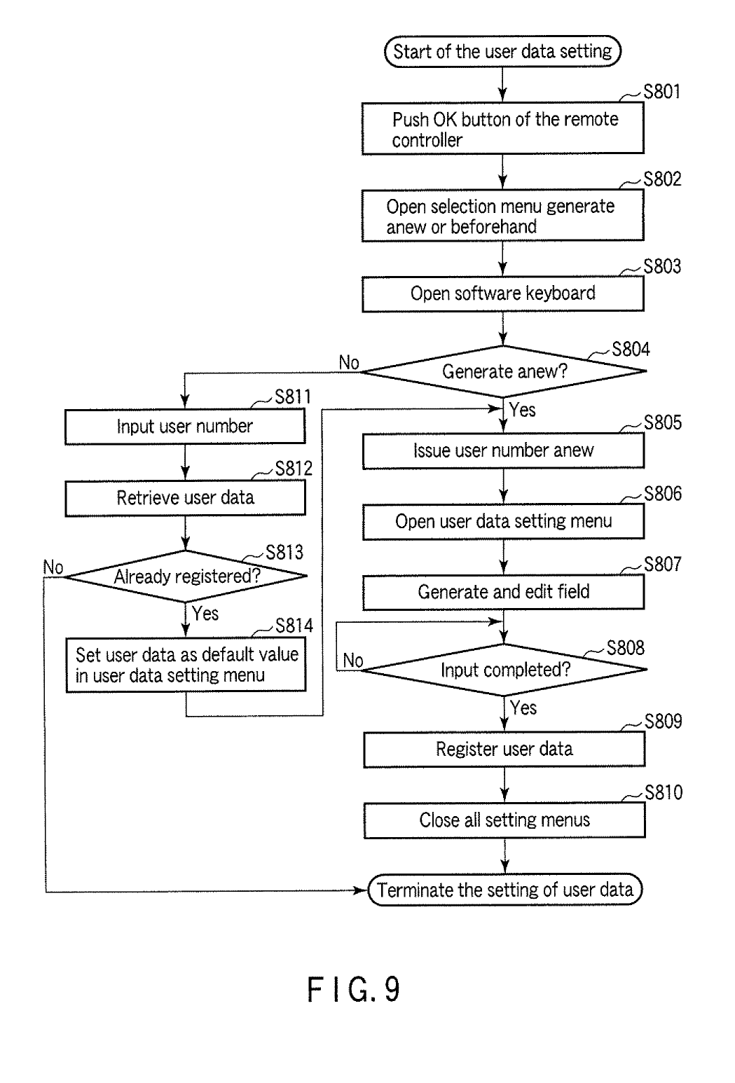

FIG. 9 is a flowchart of setting the user data. A GUI of the well-known type shown in FIG. 3 is used to set the user data. That is, the remote controller 11 is operated to set the user data. In Step S801, the user pushes the OK button of the remote controller 11, opening such a menu (selection menu) and a software keyboard as shown in FIG. 3. The menu thus opened is used to generate new user data or edit the user data available. In this embodiment, the user pushes the “YES” button displayed in the “user data setting menu 6-4” in order to set new user data.

Now that the button for setting new user data has been pushed, the user number “0” is issued in Step S805. In Step S806, the “user data setting menu 6-4” is opened. If the “NO button” is pushed to edit the user data, the decision made in Step S804 is NO. In this case, the process goes to Step S811. In Step S811, the “user number input menu 6-5” is opened. If the user inputs “0” as the user number, the user number “0” input in Step S811 is used, retrieving the user data table (FIG. 4) in Step S812. Then, in Step S814, the user data available is set as default value in the user data setting menu.

In Step S807, the user operates the software keyboard, thereby inputting the ID (=0) and the password, e.g., “soccer,” for achieving log-in to the server and the scope (=2) (i.e., the region to search for a node in the social graph), and then pushes the OK button. Any ID for achieving log-in to a server is a character string of a certain length. However, the ID is a number “0” in this embodiment, for the sake of simplicity.

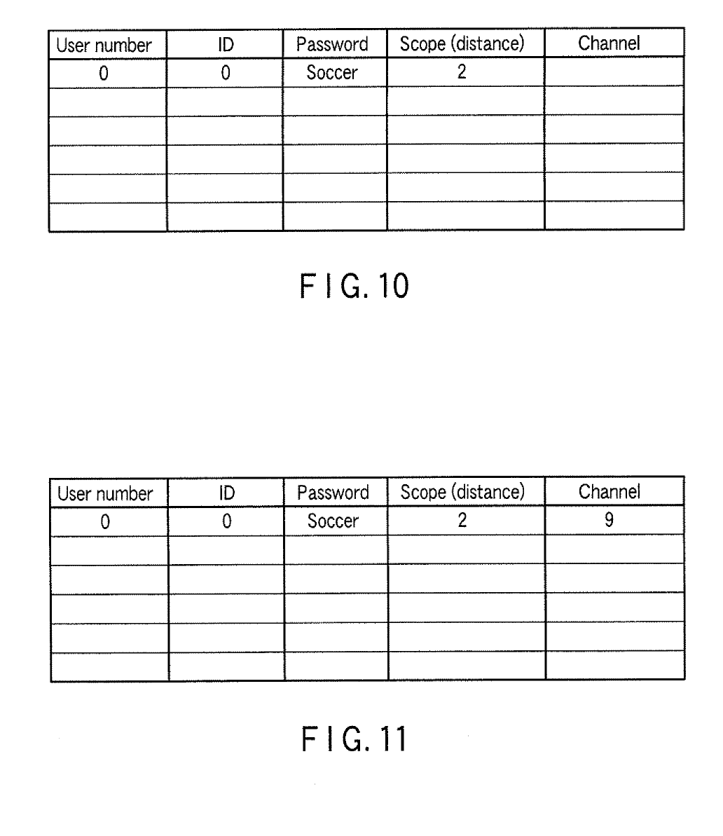

Now that the OK button has been pushed in Step S807, the ID=0, the password=soccer, and scope=2 are written in the user data table 13 in Step S809. Then, the GUI displayed on the TV screen and showing the “user data setting menu” is closed in Step S810. As a result, the user data table is set as illustrated in FIG. 10. Note that the channel, which is one field in the user data table, changes from time to time in accordance with the user's selection. That is, this field is written by the control module 9 when the client TV is connected to the service server as will be described later. (The field is not a user's profile data.)

In most cases, a password used to access the server is encrypted and then written in the table. In this embodiment, the password is written as plain text, for the sake of simplicity.

The user data table 13 is thus generated in the flow described above. Next, the client TV is connected to the service server. Note that the user data table must be set only once unless any changes are made in it.

Connection of the Client TV to the Service Server

The client TV is connected to the service server if the user pushes the “connection button” of the remote controller 11 after the user data has been set. First, the control module 9 displays the “software keyboard” and the “user number input menu,” both shown in FIG. 2. Hence, “0” is input in the present embodiment. Hence, the control module 9 sets “0” to the current user number held in the RAM area (not shown).

Next, the control module 9 uses the current user number, retrieving the user data table of FIG. 10, finding the user data. Finally, the control module 9 writes the channel data (i.e., channel 9, in this instance) the user is viewing at present, in the channel field of the user data. As a result, the user data table changes to a table shown in FIG. 11. Then, the table of FIG. 11 is used to connect the client TV to the service server.

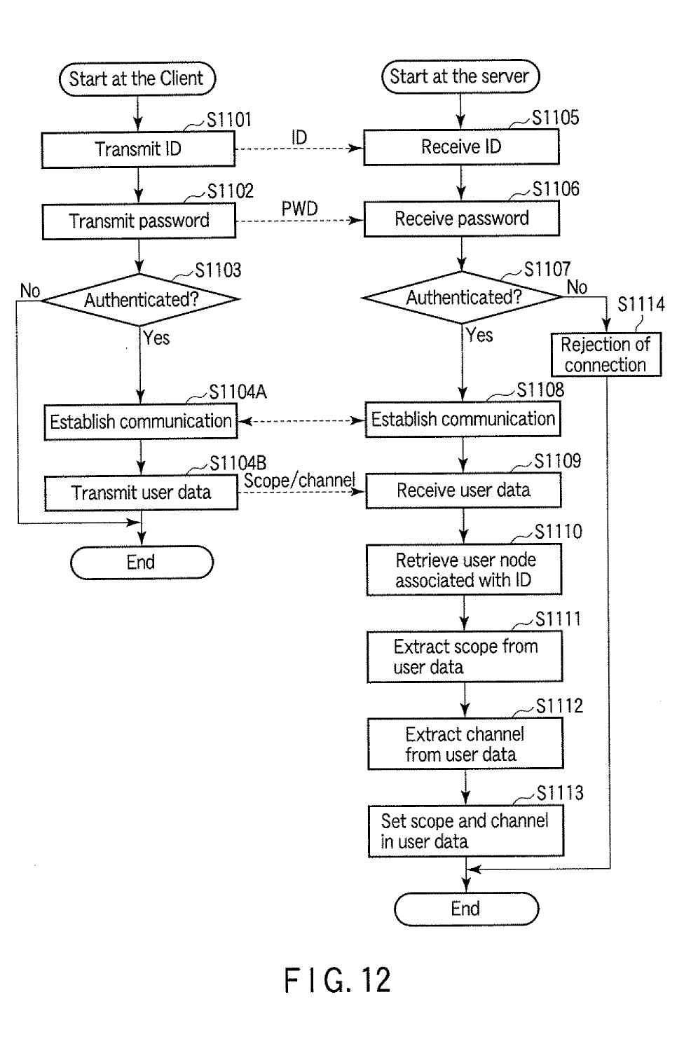

FIG. 12 is a flowchart explaining how the client TV is connected to the service server. First, the client TV transmits the ID (ID=0) of the current user to the server in Step S1101. Then, the client transmits the password (password=soccer) to the server in Step S1102. The server receives the ID in Step S1105 and the password in Step S1106, from the client, together with a connection request. The server therefore authenticates the client TV.

Whether the client TV has been authenticated is determined in Step S1103 in the client TV and in Step S1107 in the server. The server may fail to authenticate the client TV (that is, NO in Steps 1103 and 1107). In this case, the server notifies the client TV of the rejection of connection in Step S1114, and both the client TV and the server finish performing the process.

If the client TV is authenticated (if YES in Steps S1103 and S1107), the communication between the client TV and the server is established in Steps S1104A and S1108. The client TV transmits the scope (scope=2) and the channel (channel=9) to the server in Step S11104B. The server receives the user data, i.e., scope and channel, from the client TV in Step S1109.

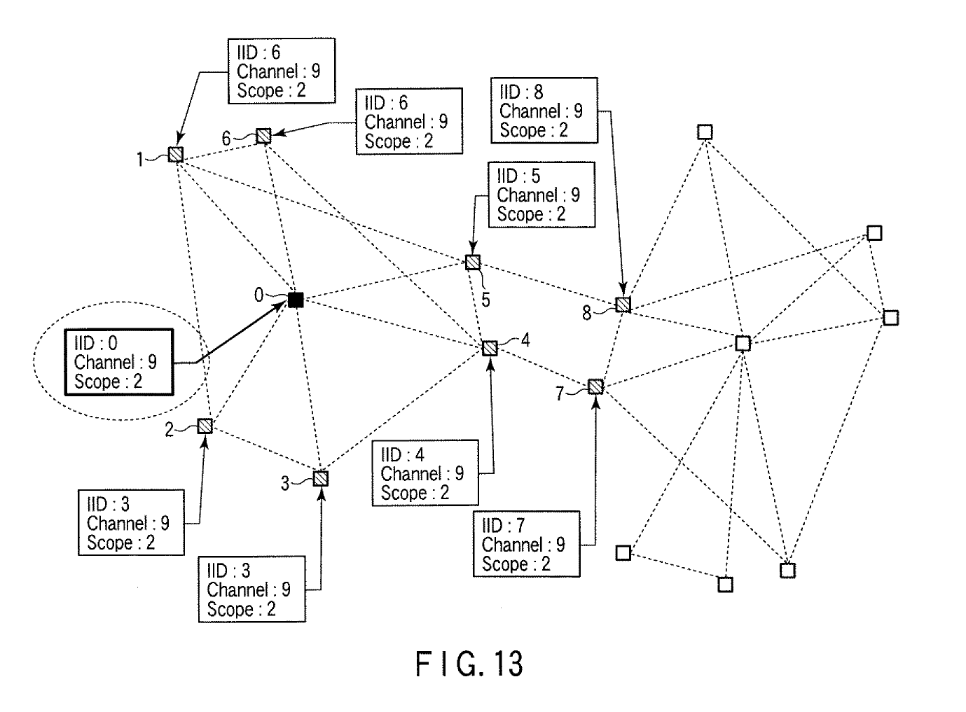

Steps S1110 to S1113 constitute a process of setting the scope and channel transmitted from the client TV at a node in the social graph. The channel (=9) and the scope (=2) are thus set at the node having an ID of 0 in the social graph, as is illustrated in FIG. 13.

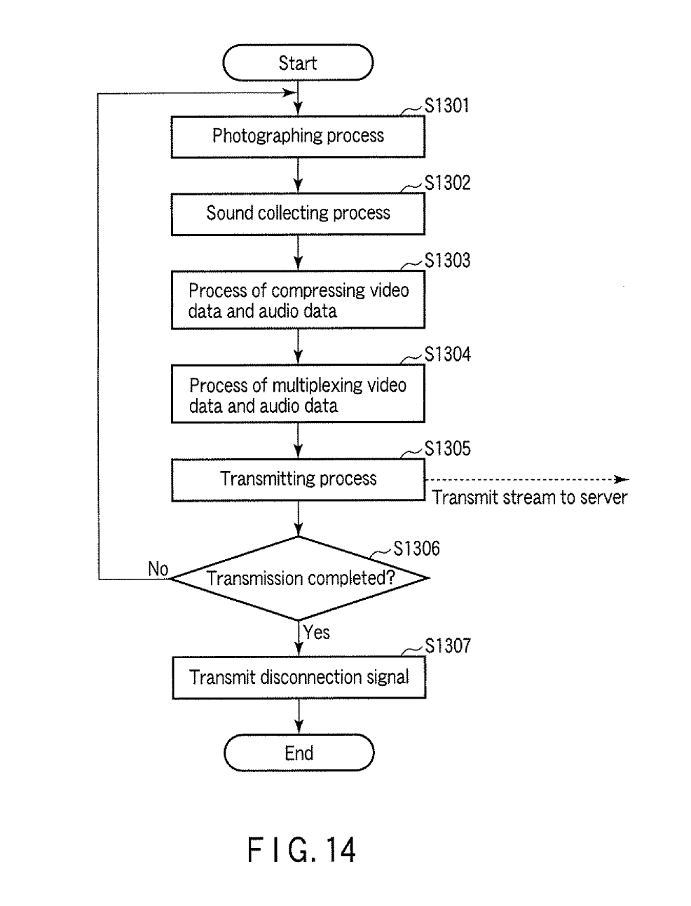

Next, the client TV starts transmitting the user's stream (audiovisual data) to the server. FIG. 14 is a flowchart explaining how a stream is transmitted from the client to the server.

In Step S1301, the camera 14 photographs the user. In Step S1302, the microphone 16 generates audio data. The audiovisual data representing the image and speech of the user is compressed in Step S1303 and then multiplexed in Step S1304. The audiovisual data, thus processed, is transmitted to the server in Step S1305.

In Step S1306, the state of the disconnection of the remote controller 11 is checked. If the disconnection button has been pushed, the data transmission is terminated, and a disconnection signal is transmitted to the server in Step S1307. The server checks the receipt of the disconnection signal from the client TV. On receiving the disconnection signal, the server stops distributing the multiplexed stream to the client TV that has transmitted the disconnection signal. The server then initializes the channel and scope of the node in the social graph and generates a new selector table (described later).

The server first generates a selector table that should be referred to at the time to distributing the stream. The process of generating a selector table is performed every time a client TV is connected to the server. That is, a selection table must be generated for any client TV (hereinafter called “destination”) that is connected to the server to receive a stream from the server. (Otherwise, no streams can be distributed between all client TVs.) For the sake of simplicity, however, it will be described how a source is determined, or how a selector table is generated, for one client TV (i.e., destination: ID=0) in the present embodiment.

In the embodiment, the shortest distance between two given nodes is determined and stored in each node of the graph in order to generate a selector table. This process is performed when the social graph changes in structure (that is, when the graph is formed, when nodes are added or deleted, or when links are added or deleted). Thus, it suffices to perform the process only once if the graph structure does not change at all.

The data representing the shortest inter-node distances set for each node shall be called “distance list” in the present embodiment. The distance list shows the IDs of partner nodes that may be connected to the node and the distances between the partner nodes and the node. In the distance list, “distance 0” is also registered as the distance of the node. The distance list can therefore be presented as follows:

Distance list={(ID of a first partner node ID, distance from the first partner node), (ID of a second partner node ID, distance from the second partner node), . . . .}

In the social graph, all nodes may be connected to one another. The distance list is therefore voluminous in proportion to the number of nodes that exist in the graph. Since the distance list is used to find some friends, it is sufficient to register in the distance list only the nodes connected over a distance of at most 2 to 3 (i.e., to friend's friend to a friend of the friend's friend) in the graph. Particularly in this embodiment, the IDs of the nodes connected over distances of at most 2 (friend's friend) at most are registered in the distance list, for the sake of simplicity. This distance range is called MAX_DIST, which defines the depth of searching other nodes connected to the node. MAX_DIST=2 in this embodiment. That is, up to the friend's friends may be searched in the present embodiment.

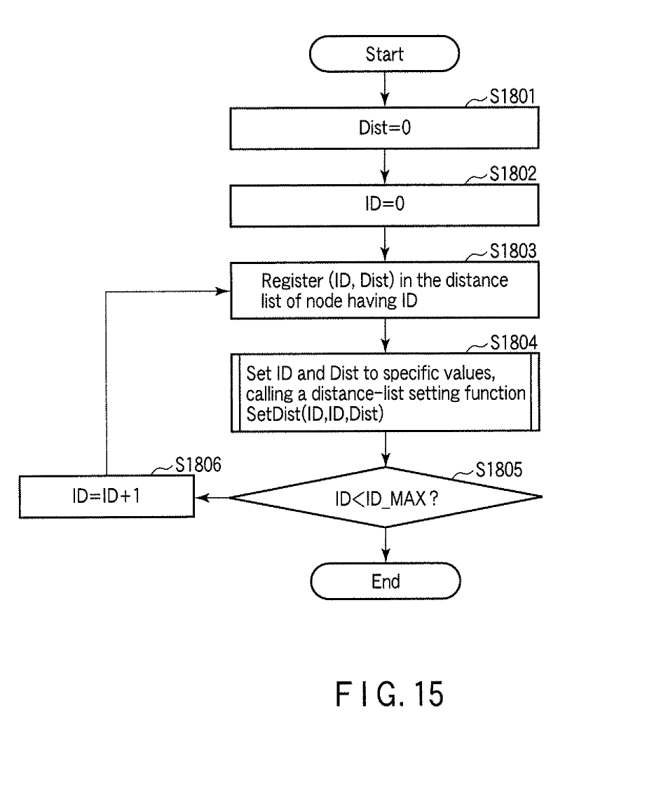

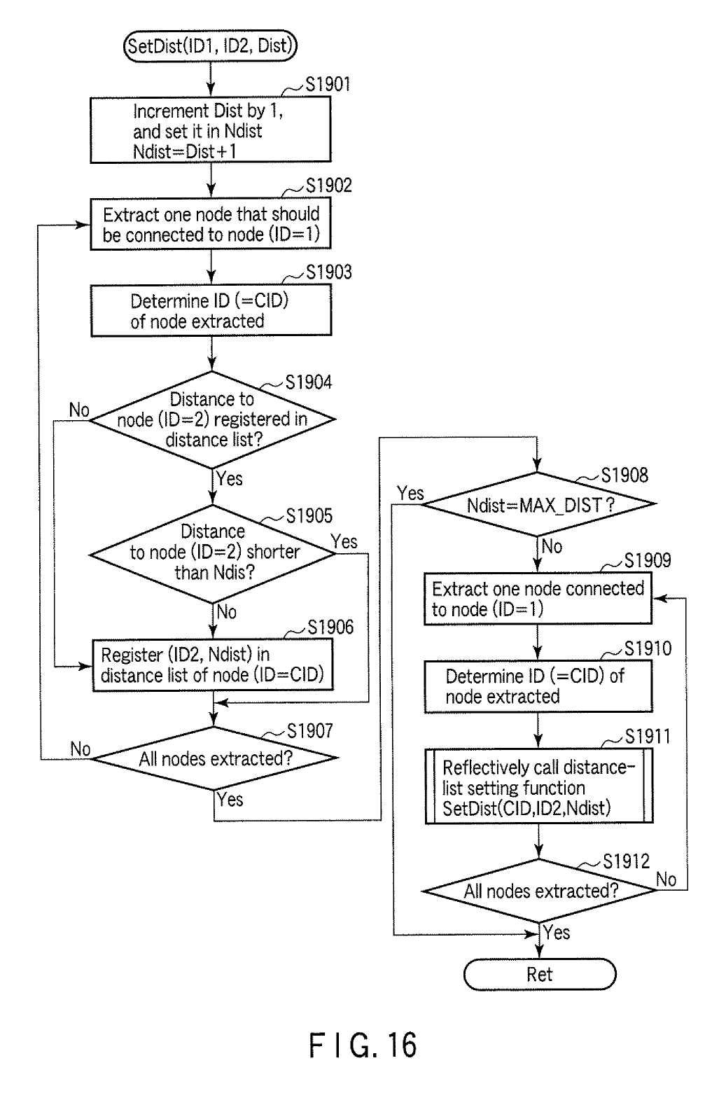

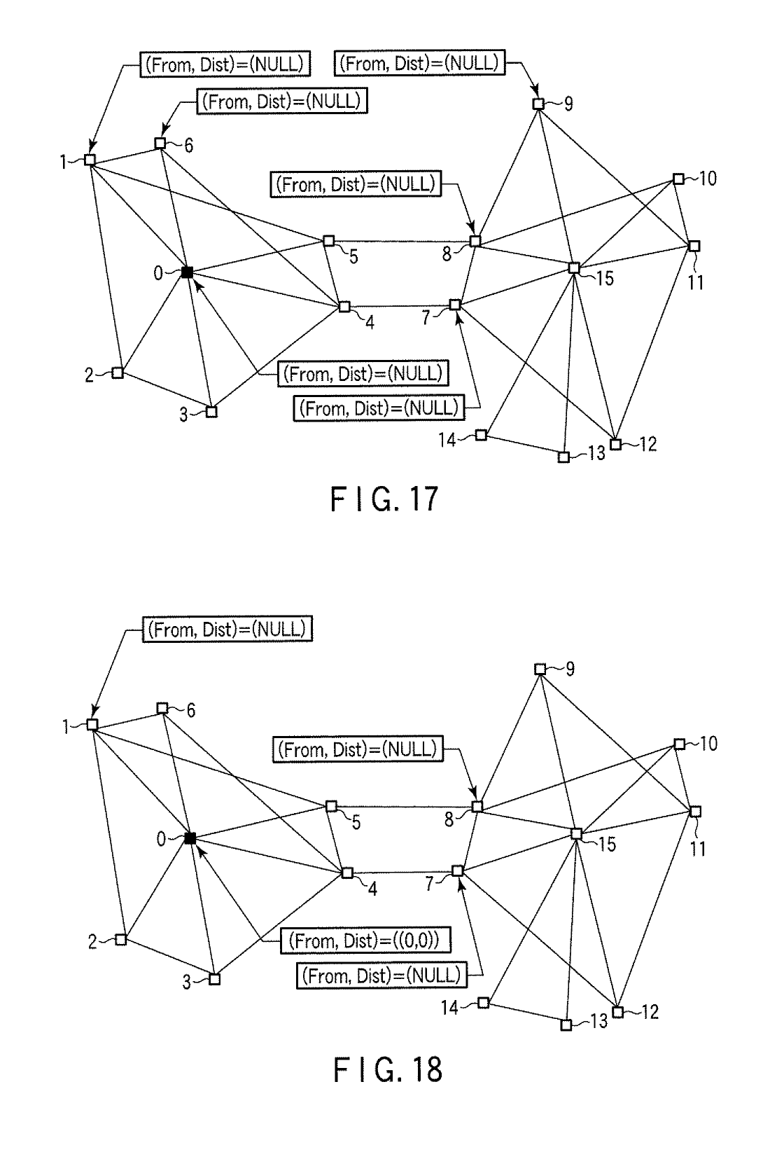

FIG. 15 is a flowchart explaining how the distance list is generated in respect of each node in the social graph. FIG. 16 is a part of the flowchart of FIG. 15, or a flowchart concerning distance-list setting functions. How a distance list is set for each node will be explained, taking the social graph shown in FIG. 17 as an example. Unique IDs (i.e., numbers) are allocated to all nodes in the social graph, each identifying one node. The maximum value for each ID is managed by using a variable called ID_MAX. In the social graph of FIG. 17, the nodes have IDs ranging from 0 to 15, and ID_MAX=16.

First, the variable is initialized in Steps S1801 and 1802. In Step S1803, (0, 0) is registered in the distance list of the node having ID=0. This value, (0, 0), means that the distance between the node having ID=0 and the node having ID=0, i.e., the same node, is 0 (see FIG. 18).

In Step S1804, a distance-list setting function SetDist (i.e., ID of the node being processed, ID of the starting node, and distance) is acquired, and the nodes within the distance range MAX_DIST, including the node having ID=0, are registered in the distance list. Steps S1803 to S1806 are repeated, generating a distance list of all nodes existing in the social list (i.e., nodes having IDs ranging from 0 to 15).

The process of Step S1804 (i.e., acquisition of the distance-list setting function SetDist) is shown in detail in the flowchart of FIG. 16. This process retrieves other nodes connected to the node that is the starting point of width-preferential retrieval.

Once the node ID=0 (i.e., node being processed), the starting-point node ID=0, and distance=0 are applied, thus acquiring the distance-list setting function SetDist ( ) the distance is incremented to 1 and set at Ndist in Step S1901.

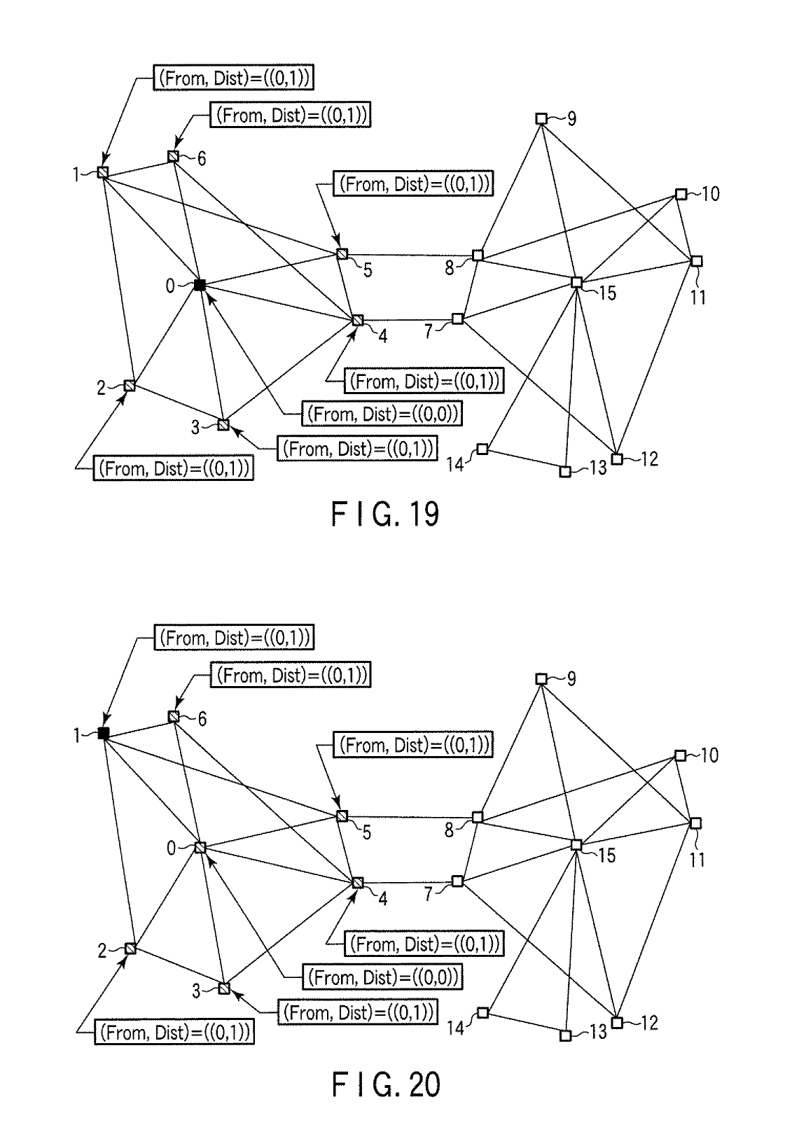

First, ID=1 is found as one node connected to the node being processed (=0). Since the (CID=1) distance list has not been registered yet, the ID=0 and Ndist=1 of the node at the starting point are added, as a pair, to the distance list for the node having ID=1. The node having ID=0 is connected to the nodes having IDs ranging from 1 to 6, (0, 1). Therefore, when each node is processed, (0, 1) is registered in the distance list for the node. This means that the nodes having IDs ranging from 1 to 6 are at a distance of 1 from the node having ID=0 (see FIG. 19).

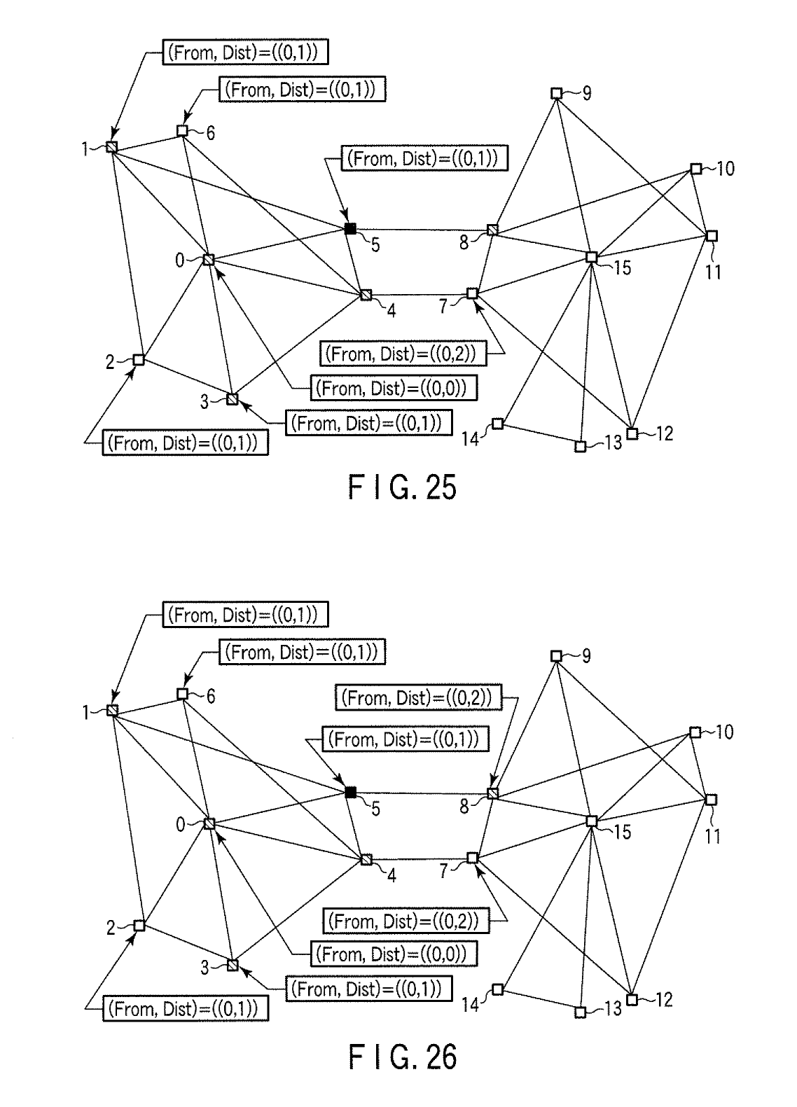

If Ndist=1, MAX_DIST=2. Hence, a node is further searched for in the direction of depth in Step S1908. The nodes having IDs ranging from 1 to 6 are connected to the node having ID=0. Therefore, if the distance-list setting function SetDist ( ) is reflectively called for each of these nodes, distance lists will be set for the nodes having IDs ranging from 1 to 8 (see FIG. 20 to FIG. 27).

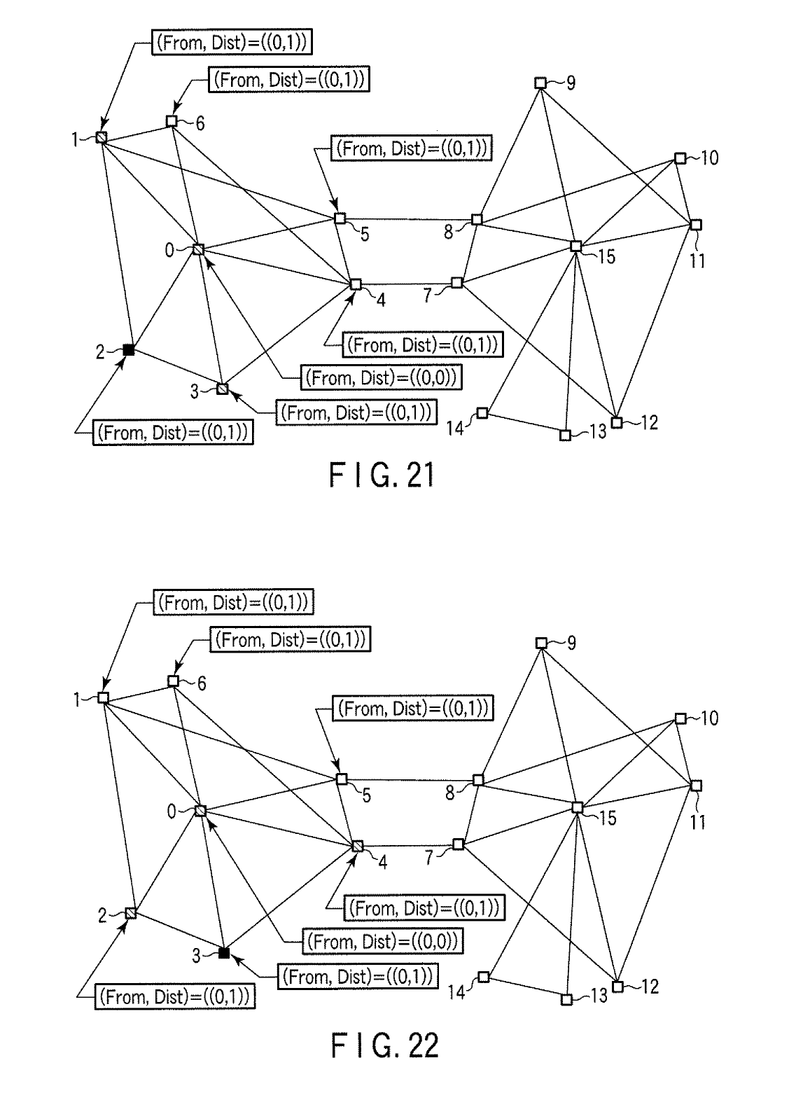

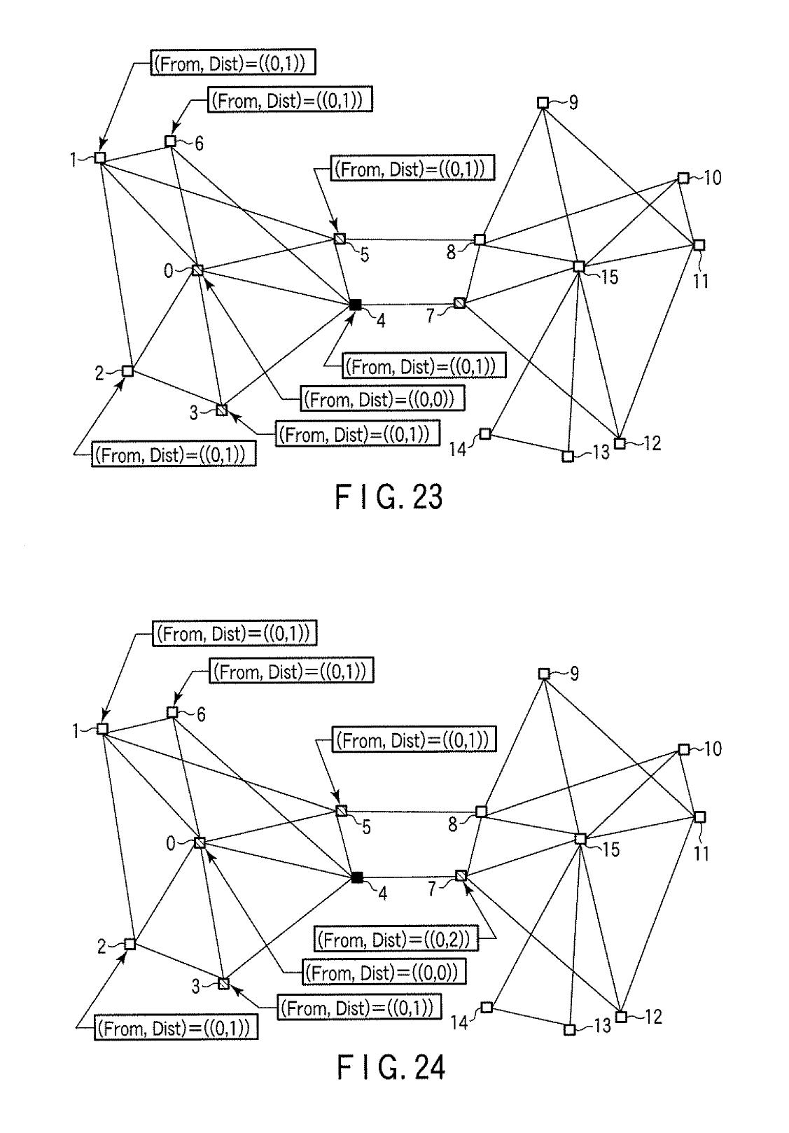

FIG. 20 shows the case where a distance list is generated for the node ID=1. FIG. 21 shows the case where a distance list is generated for the node ID=2. FIG. 22 shows the case where a distance list is generated for the node ID=3. FIG. 23 shows the case where a distance list is generated for the node ID=4.

If a distance of 2 from the node having an ID of 1 is searched for, two nodes connected to the node having an ID of 1 will be found, i.e., nodes having IDs of 0 and 6, respectively. The node having an ID of 0 is the node that has an ID of 6, i.e., starting point, and the node having an ID of 2 is a node that is directly connected to the node having an ID of 0. The distances of these nodes have already been registered as (0, 1). In this case, it can be determined that no nodes at a distance of 2 from the node having an ID of 0 are connected to the node having an ID of 1.

To prevent the data about any starting-point node or any node registered in the distance list from being overwritten, the registered nodes are identified before nodes are registered anew in Steps S1904 and S1905 of the flowchart shown in FIG. 16. In order to identify any registered node, the distance of 0 is set for the starting-point node in this embodiment, and then the width-preferential retrieval of nodes is performed. The nodes retrieved are registered in the distance list one after another, the first being the node nearest the staring-point node and the last being the node farthest from the starting-point node.

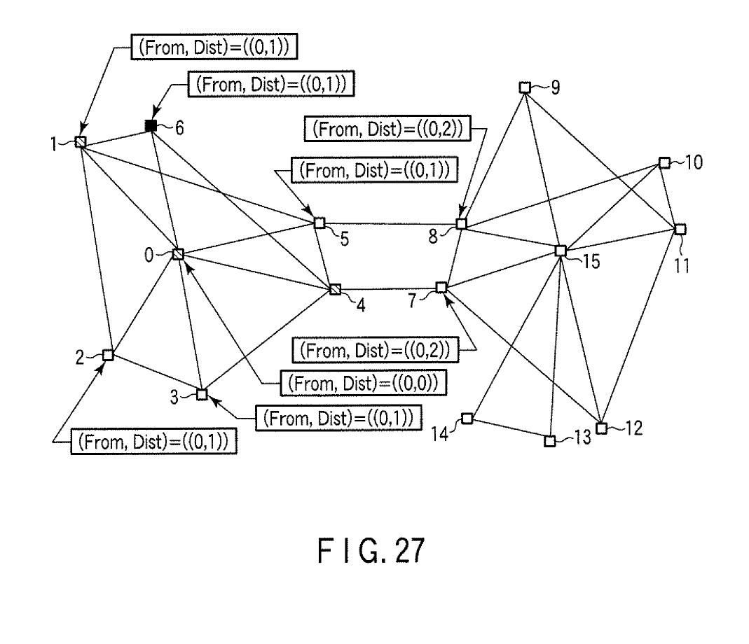

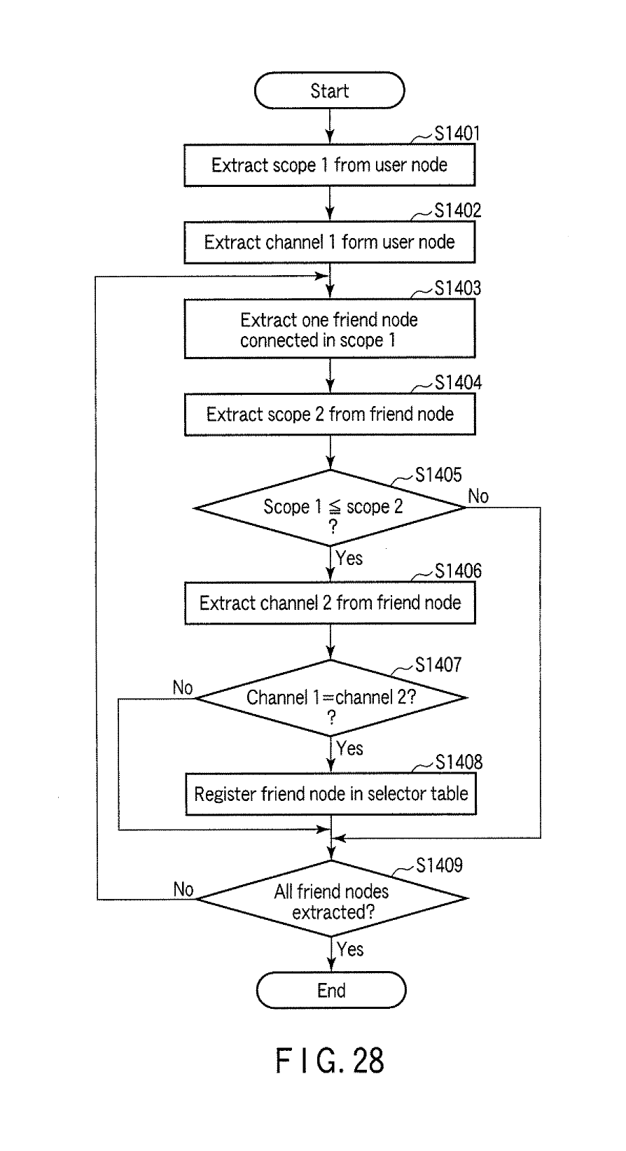

Assume that the distance lists of the nodes in the social graph have been set as shown in FIG. 27. FIG. 28 is a flowchart explaining how a selector table is generated for one client TV (destination) based on this assumption.

As shown in FIG. 28, scope 1, i.e., “2,” is extracted from the user node (ID=9) corresponding to the client TV. Channel 9 is extracted from the user node. (Steps S1401 and S1402) Next, any node connected to the user node (i.e., node called “friend node”) is searched for in the social graph, and a friend node (ID=1) is found and extracted. The scope of this friend node (i.e., scope 2) is extracted. (Steps S1403 and S1404)

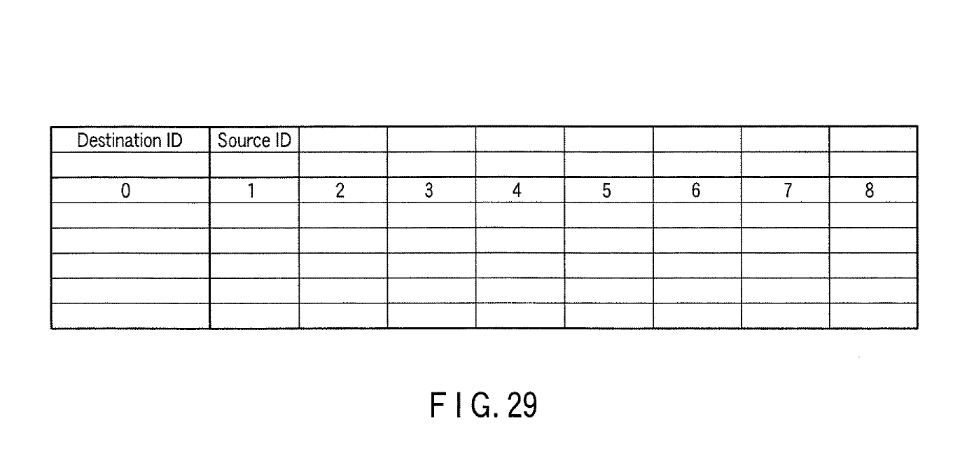

Scope 1≦scope 2, and the channel of the friend node (ID=1) is “9.” This means that the friend is viewing the same channel as the user. Therefore, the friend node (ID=1) is registered in the selector table. (Steps S1405 and S1408) To determine whether scope 1≦scope 2 is to determine “whether the communication partner regards the user as a friend, too.” As the process of Steps S1403 to S1409 is repeated, the friend nodes (ID=2 to 8) are connected to the user node (ID=0) in the region of scope 2. Since all these friend nodes meet the condition for registration in the selector table, the selector table changes to such a table as shown in FIG. 29.

Thus, the process of generating a selector table is a process of searching the social graph for the friends who are viewing the same channel as the user.

Displaying the Stream on the Sub-Display

In this embodiment of the invention, the client TV and the service server perform their respective processes in synchronism, parallel to each other. The process described below is performed after the stream has been transmitted to the client TV and the service server has generated the selector table.

As in generating the selector table, the multiplexed stream must be distributed to all client TVs connected to one another, which are destinations. In this embodiment, a stream is distributed from one client TV to another client TV, for the sake of simplicity.

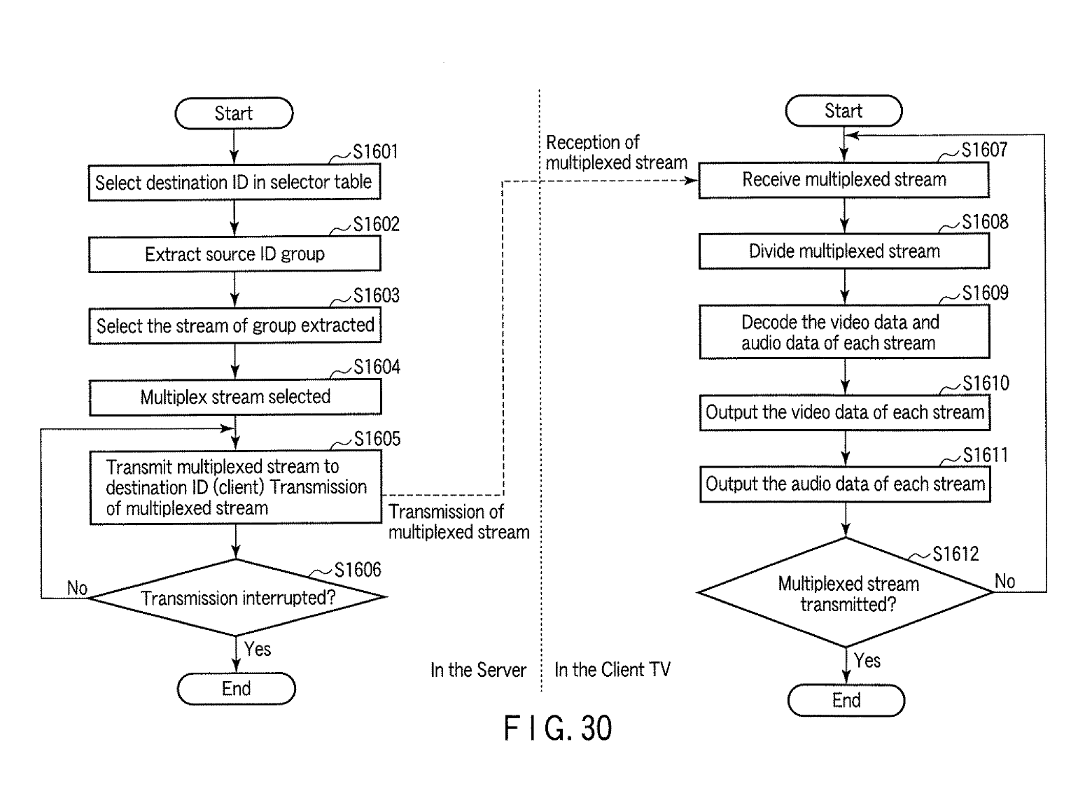

FIG. 30 is a flowchart explaining how the server distributes a stream to a certain client TV (i.e., destination).

In Step S1601, the server selects the destination having an ID of 0 in the selector table. P In Steps S1602 and S1603, the server refers to the selector table and selects the stream of sources (ID=1 to 8), from the stream it has received. In Step S1604, the server multiplexes eight streams of the sources (ID=1 to 8), generating a multiplexed stream. The multiplexed stream is transmitted to the client TV (ID=0). The data distribution is continued until the client TV sends a disconnection signal (Steps S1605 and S1606).

The client TV receives the multiplexed stream from the server and divides the multiplex stream into eight streams for the eight other client TVs. Then, the client TV decodes each stream into video data and audio data (Steps S1607 to S1609).

The image is displayed by the sub-display 26, and the sound of each stream and the sound of the TV broadcast program are mixed and then output to the speaker (Steps S1610 to S1611). This process is continued until the data transmission from the server stops (Step S1612 and Steps S1608 to S1611).

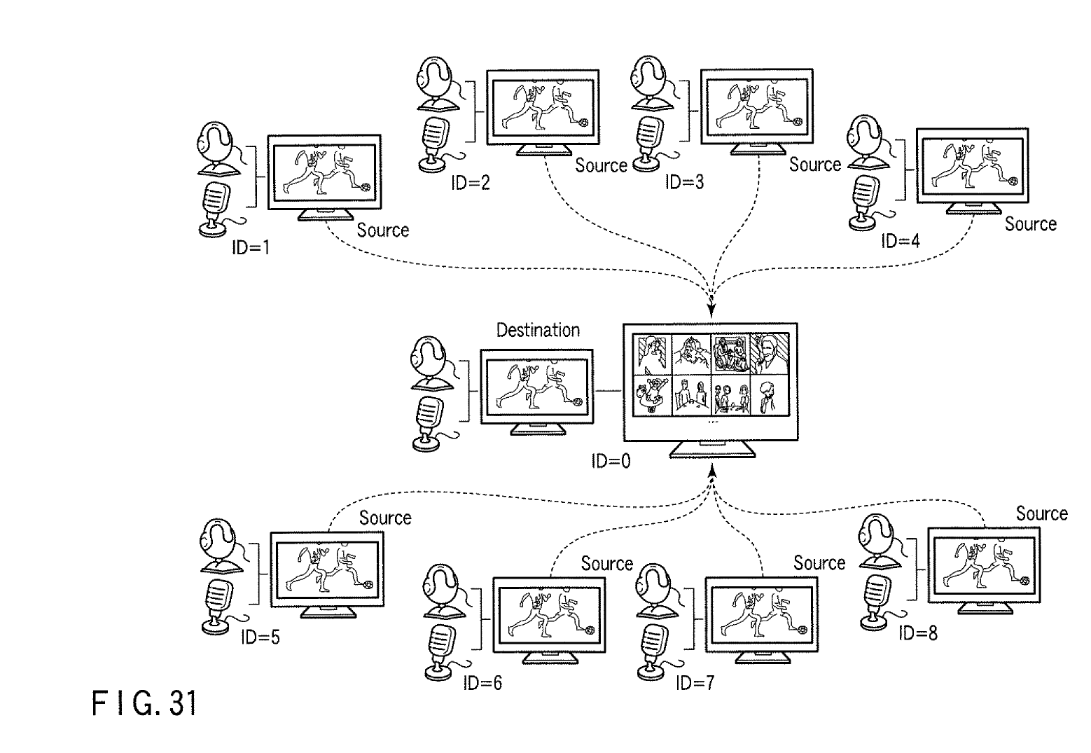

In the process described above, the sub-display of the client TV displays, for example, the friends enjoying the program, the user (viewer) is now watching the program, as is illustrated in FIG. 31. Similarly, the stream of the user is, of course, displayed in one window of the sub-display of the friends' client TVs, only if a selector table is generated for all client TVs connected to the user's client TV.

Thus, the user can appreciate the program together with the user's friends, while seeing the friends' images in real time, on the basis of the human relation defined by the wide social graph. According to this invention, the social graph now available is utilized, enabling the user to appreciate a TV program without the necessity of registering friends. Moreover, since the human relation defined changes as the social graph changes, the user can enjoy the TV program as if he or she had got together with friends in a sports bar, enjoying watching a soccer game. In view of this, this invention can best be used to watch a game broadcast live, such as a soccer game.

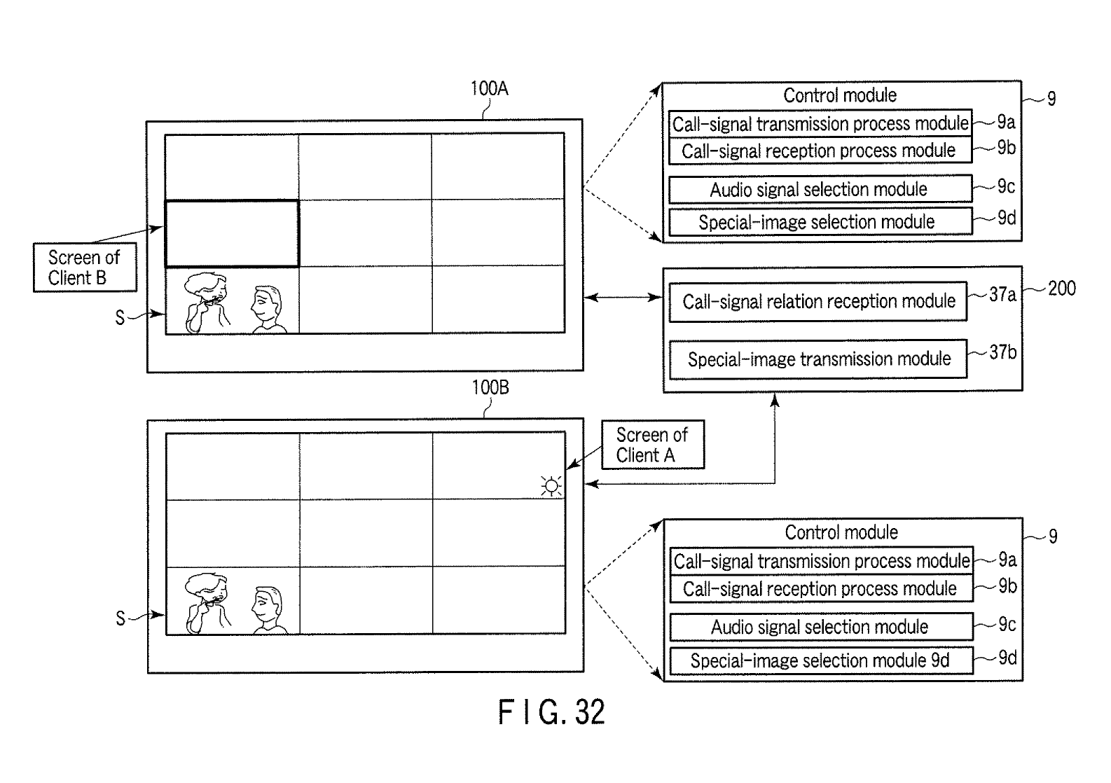

To enable the user to talk with a certain person as illustrated in FIG. 32, the client TV may have the function of transmitting a call signal. That is, the user may move the cursor, selecting a particular small image, thereby transmitting a call signal. The control module 9, for example, has a call-signal transmission processing module 9a and a call-signal reception processing module 9b. Assume that the viewer of the client TV 100A wants to talk with the viewer of the client TV 100B. Then, the viewer of the client TV 100A moves the cursor, selecting the small image transmitted from the client TV 100B. The data representing this selection is added to the user data, which is transmitted to the server 200. In the server 200 that receives the call signal, a call-signal relation reception module 37a operates, adding the call signal (having the ID of the client TV 100A) to the data that should be transmitted to the client TV 100B. The data now including the call signal is transmitted from the server 200 to the client TV 100B. In the client TV 100B, a flashing mark, for example, is displayed in the small image (specific image) transmitted from the client TV 100A. Seeing this mark, the viewer of the client TV 100B can know that the viewer of the client TV 100A is now calling. In this case, a part of the specific image or the frame thereof may be flashed.

In response to the call, the viewer of the client TV 100B makes a telephone call to the viewer of the client TV 100A, or the audio signal selection module 9c provided in the control module 9 performs a selection process, outputting only the audio data coming from the client TV 100A. The users of the client TVs that have selected each other can thus talk with each other.

Further, the server 200 may have a special-image transmission module 37b. If so, the client TVs have a special-image selection module 9d. Special-image signals are independent of, for example, the search region, and may be received if the users of the client TVs pay a charge. If any client TV receives a special-image signal, an image S will be displayed at the client TV as shown in FIG. 32. In this case, only the audio signal for this image S can be selected.

Having such a function, the client TV can transmit the video signal representing the image of any actor, commentator or master of ceremonies, appearing in the program the user is now viewing. That is, the user can hear the comment on the program, from the director, actor or the like.

This invention is not limited to the embodiment described above. The components can be modified in various manners in reducing the invention to practice, without departing form the scope or spirit of the invention.

In the embodiment, the client TV has two displays, i.e., the main display and the sub-display. A sub-window may, of course, be provided in the main display and be used in place of the sub-display.

In the embodiment, the “scopes of the user and his or her friend” and the “channels the user and friend are viewing” are used as conditions for registering the friend, for the sake of simplicity.

The “sex, age, hobby, address and the like,” which are registered in the social graph, may be set, too, as conditions for registering the friend. Further, the members who have a particular factor may be excluded from the friends.

In the embodiment, only one person is assumed to watch each client TV, and the ID of this person is used as the current user ID. Instead, the current user IDs may be written in a list, whereby a plurality of current user IDs are set each time. In this case, the user can appreciate the same program, together with the friends of all family members (including the friends of the parents, the friends of the children, etc.).

The embodiment is designed for use in a terrestrial digital broadcasting system. Needless to say, this invention can also be implemented in any cable TV system or satellite broadcasting system, too.

In the embodiment, each client TV transmits and receives both video data and audio data. Nonetheless, the client TV may transmit and receive only the video data or the audio data. For example, the client TV may join the social graph, transmitting, for example, the audio data only, and not transmitting the video data. If this is the case, a still picture, such as an icon, is displayed on the sub-display.

In the embodiment, audio data items are mixed and then output to one speaker. Nonetheless, the microphone connected to each client TV may be replaced by a headset, which inputs audio data and, at the same time, distributes the audio data. This enables each user to select the very sound he or she wants to listen to.

In the embodiment, each client TV transmits a stream, without processing it at all. Before transmitting the stream, the client TV may analyze the video data, may extract a gesture (e.g., strongman pose) and blend the gesture with an effect, and may transmit the stream containing the video data representing the gesture and the effect. (The effect is, for example, characters, e.g., “Great,” or an icon, e.g., a V sign.)

In the embodiment, each client TV transmits a stream, without processing it at all. Before transmitting the stream, the client TV may analyze the video data, may detect a cry and blend the cry with an effect, and may transmit the stream containing the audio data representing the cry and the video data representing the effect. (The effect is, for example, characters, e.g., “Great,” or an icon, e.g., a V sign.)

In the embodiment, each client TV receives stream data only. Nonetheless, the client TV may receive text data and image data, in addition to the stream data. For example, a keyboard may be connected to the client TV and the client TV may transmit the character data input at the keyboard. Further, any image data generated by the camera connected to the client TV may be transmitted to the friends.

In the conventional technique, such as a TV conference system, the participants must be registered at the service provider beforehand, and no persons other than the registered members can exchange streams. The human relation possible with this technique is exclusive. The technique has indeed no problems if used to achieve a businesslike relation. However, the technique cannot achieve a human relation orientated to entertainment that enables the members to enjoy viewing images, together with new participants (e.g., friends' friends). The present invention can solve this problem. With the conventional technique, much labor is required to register all participants at a particular provider, and each participant cannot easily switch the provider to any other. This invention solves this problem, too, utilizing the human relation established in the social graph to enable many people to view the same program. The use of the social graph renders it unnecessary to register the friends or to do anything to maintain the human relation. Moreover, each user can expect chance meetings with new members such as “friends of the friend's friend,” merely by changing the search region (scope) in the social graph, in which the network changes from time to time. Therefore, the user can enjoy the TV program as if he or she had got together with the friends in a sports bar, enjoying watching a soccer game. In view of this, this invention can best be used to watch sport games.

The present invention is not limited to the embodiment described above. The components of the embodiment can be modified in various manners in reducing the invention to practice, without departing from the spirit or scope of the invention. Further, the components of the embodiment described above may be combined, if necessary, in various ways to make different inventions. For example, some of the components of any of the embodiments may not be used. Moreover, the components of different embodiments may be combined in any desired fashion.

While certain embodiments of the invention have been described, these embodiments have been presented by way of example only, and are not intended to limit the scope of the inventions. Indeed, the novel methods and systems described herein may be embodied in a variety of other forms; furthermore, various omission, substitutions and changes in the form of the methods and systems described herein may be without departing from the spirit of the inventions. The accompanying claims and their equivalents are intended to cover such forms or modifications as would fall within the scope and spirit of the inventions.

What is claimed is:

1. An audiovisual apparatus comprising:
a broadcast-program signal processing module configured to process a broadcast program signal received by a first reception module and to output the broadcast signal to a first display area;
a grouped-video signal processing module configured to process a grouped video signal received by a second reception module and to output the grouped video signal, in the form of a multi-image, to a second display area; and
a transmission module configured to process a pickup image signal and transmit the pickup image signal to an external apparatus.

2. The audiovisual apparatus of claim 1, wherein the transmission module is further configured to transmit user data to the external apparatus, the user data including channel data about a channel being viewed and search data contributing to acquisition of the grouped video signal.

3. The audiovisual apparatus of claim 2, further having an operation module configured to operate as a user interface to input the search data.

4. The audiovisual apparatus of claim 1, wherein the second reception module is further configured to receive a grouped audio signal associated with the grouped video signal, and the grouped audio signal is processed by a grouped-audio signal processing module.

5. The audiovisual apparatus of claim 4, wherein the grouped-audio signal processing module is able to select and output one or more audio signals included in a group, in response to an operation input.

6. The audiovisual apparatus of claim 1, wherein the first display area and the second display area are located in a first display device and a second display device, respectively.

7. The audiovisual apparatus of claim 1, wherein the second display area is composed of a plurality of display devices.

8. The audiovisual apparatus of claim 1, wherein the second display area is a display of a personal computer.

9. The audiovisual apparatus of claim 1, further comprising a call-signal transmission processing module configured to transmit a call signal designating a small image displayed in the multi-image, by moving a cursor.

10. The audiovisual apparatus of claim 1, further comprising a call-signal reception processing module configured to flash a part or frame of the small image when the call signal designating the small image displayed in the multi-image is received.

11. The audiovisual apparatus of claim 1, wherein the grouped-video signal processing module further configured to select and output a video signal representing an image of an actor, commentator or master of ceremonies, related to the broadcast program signal, to a small image displayed in the multi-image, by moving a cursor.

12. A method of controlling an audiovisual apparatus, comprising:
processing a broadcast program signal received by a first reception module and outputting the broadcast signal to a first display area;
processing a grouped-video signal received by a second reception module and outputting the grouped video signal, in the form of a multi-image, to a second display area;
transmitting a pickup image signal to a network; and
transmitting user data to the network, the user data including channel data about a channel being viewed and search data contributing to acquisition of the grouped video signal.

13. A method of distributing data, using a transmission/reception module, a control module, a data storage module and a processing module, the method comprising:
setting nodes corresponding to a plurality of clients;
storing, at each node, at least a client number transmitted from the client corresponding to the node, a search region equivalent to a distance between a center node and any other node, and user data including the number of the channel the client corresponding to the center node is viewing;
referring to the user data, thereby setting a social graph in response to a request made by a specific client, the social graph showing a plurality of related nodes, with the specific client used as a center node, each related node holding data of the channel being viewed; and
transmitting a grouped video signal to the specific client, the grouped video signal being an image signal sent from each client that belongs to the social graph.

14. The method of claim 13, wherein a grouped audio signal is transmitted to the specific client.
